(19) United States
(12) Patent Application Publication
(10) Pub. No.: US 2026/0289228 A1
(43) Pub. Date: Sep. 24, 2026

(54) RADIO-FREQUENCY-BASED DEEP NEURAL NETWORKS

(71) Applicant: University of Massachusetts, Westborough, MA (US)

(72) Inventors: Hualiang Zhang, Arlington, MA (US); Bowen Zheng, Lowell, MA (US); Yunxi Dong, Lowell, MA (US)

(21) Appl. No.: 19/563,141

(22) Filed: Mar. 11, 2026

Related U.S. Application Data
(60) Provisional application No. 63/773,511, filed on Mar. 18, 2025.

(51) Int. Cl. G06N 3/04

(52) U.S. Cl. CPC G06N 3/04

(57) ABSTRACT

Examples described herein provide a method for performing artificial intelligence operations using a radio frequency-based deep neural network. The method includes receiving an input. The method further includes causing a reflective metasurface to generate a representation of the input using voltage values generated based on the input. The method further includes transmitting a radio-frequency wave using a transmission antenna, the radio-frequency wave at least partially reflecting off and spatially modulated by the reflective metasurface to generate a reflection wave. The method further includes generating a measurement based on the reflection wave, the reflection wave being detected by a reception antenna. The method further includes performing the artificial intelligence operation based on the measurement.

### CROSS-REFERENCE TO RELATED APPLICATIONS

This application claims the benefit of U.S. Provisional Application No. 63/773,511, filed Mar. 18, 2026, and incorporates the contents thereof by reference in their entirety.

### BACKGROUND

Embodiments described herein generally relate to artificial intelligence, and more specifically, to radio frequency-based deep neural networks.

Deep neural networks are widely used in machine learning and artificial intelligence (AI) applications to perform tasks such as classification, prediction, and feature extraction. These networks typically include multiple layers, including convolutional layers, fully connected layers, and nonlinear activation functions, which enable complex data transformations and learning from large datasets.

Some implementations of deep neural networks rely on digital processing systems, such as central processing units (CPUs), graphics processing units (GPUs), and specialized accelerators, to execute mathematical operations and manage data flow. Alternative computing paradigms have emerged, including analog in-memory computing and photonic neural networks, which leverage physical phenomena to perform neural computations. These approaches aim to enhance energy efficiency, speed, and scalability by utilizing electromagnetic, optical, or analog signal processing techniques.

### SUMMARY

According to an embodiment, a method for performing artificial intelligence operations using a radio frequency-based deep neural network is provided. The method includes receiving an input. The method further includes causing a reflective metasurface to generate a representation of the input using voltage values generated based on the input. The method further includes transmitting a radio-frequency wave using a transmission antenna, the radio-frequency wave at least partially reflecting off and spatially modulated by the reflective metasurface to generate a reflection wave. The method further includes generating a measurement based on the reflection wave, the reflection wave being detected by a reception antenna. The method further includes performing the artificial intelligence operation based on the measurement.

According to an embodiment, a system for performing artificial intelligence operations using a radio frequency-based deep neural network is provided. The system includes an enclosure comprising a plurality of walls, a top and a bottom. The system further includes a reflective metasurface, a transmission antenna, and a reception antenna. At least one of the plurality of walls includes a reflective/absorptive portion. The reflective/absorptive portion is configured to reflect radio-frequency waves in a first bandwidth and configured to absorb radio-frequency waves in a second bandwidth different than the first bandwidth.

According to an embodiment, a method for performing inference using a neural network comprising a plurality of layers is provided. The method includes executing, by a digital processor, one or more linear operations of a current layer of the neural network. The method further includes transferring an intermediate representation from the digital processor to a radio frequency neural network (RFNN) core comprising a reconfigurable metasurface. The method further includes performing, by the RFNN core, a nonlinear transformation of the intermediate representation via radio-frequency wave propagation and scattering, the reconfigurable metasurface being configured with voltage values corresponding to the current layer. The method further includes transferring a scattering output from the RFNN core to the digital processor. The method further includes generating an output of the current layer based at least in part on the scattering output.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIGS. 1A and 1B illustrate a non-linear RF-based DNN and a linear RF-based DNN 102, respectively, each being configured for radio frequency-based deep neural network operations according to one or more embodiments;

FIGS. 2 and 3 illustrate a configuration of a RF-based DNN that supports the non-linear and linear configurations of FIGS. 1A and 1B according to one or more embodiments;

FIG. 4 illustrates an RF-based DNN process for performing artificial intelligence operations according to one or more embodiments;

FIG. 5 illustrates a confusion matrix illustrating classification performance of an example RF-based DNN according to one or more embodiments;

FIG. 6 illustrates a spatiotemporal embedding architecture according to one or more embodiments;

FIG. 7 illustrates a fully analog inference pipeline according to one or more embodiments;

FIG. 8 illustrates a PCB-level implementation for an RF-based DNN according to one or more embodiments;

FIG. 9 illustrates a chip cross-section of an RF-based DNN according to one or more embodiments;

FIG. 10 illustrates an architecture for various neural operation modes according to one or more embodiments;

FIG. 11 illustrates a co-processing architecture for neural network inference according to one or more embodiments;

FIG. 12 illustrates a flow diagram of a method for performing an artificial intelligence operation using a radio frequency-based deep neural network according to one or more embodiments;

FIG. 13 illustrates a flow diagram of a method for performing an artificial intelligence operation using a radio frequency-based deep neural network according to one or more embodiments;

FIG. 14 illustrates a flow diagram of a method for performing inference using a neural network comprising a plurality of layers according to one or more embodiments; and

FIG. 15 illustrates a block diagram of a processing system for implementing one or more embodiments described herein.

The detailed description explains embodiments of the disclosure, together with advantages and features, by way of example with reference to the drawings.

### DETAILED DESCRIPTION

One or more embodiments described herein support artificial intelligence (AI) reasoning to accomplish various machine learning operations, such as performing classification, by implementing radio frequency-based deep neural networks (RF-DNNs).

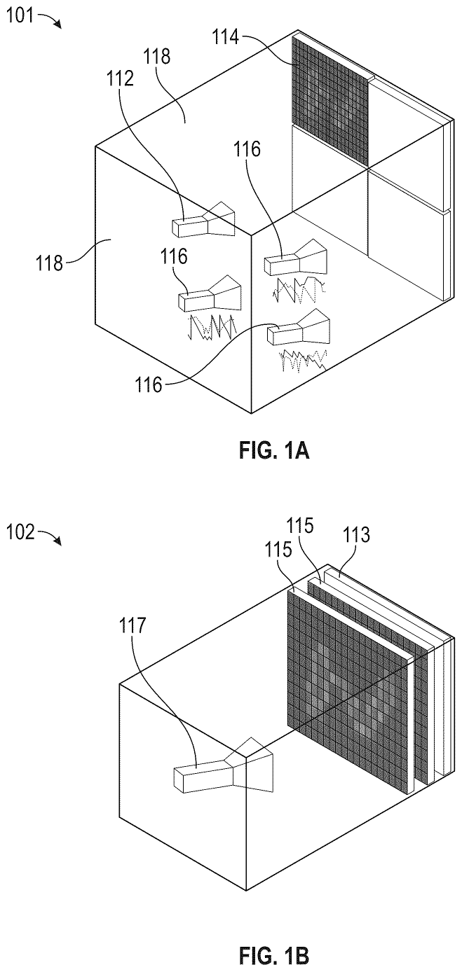

These embodiments generally pertain to the field of artificial intelligence and machine learning, with particular emphasis on leveraging electromagnetic phenomena for neural network operations. While described primarily in the RF domain, the underlying wave-based computing principles apply across the electromagnetic spectrum, and embodiments at microwave, millimeter-wave, terahertz, and optical frequencies are contemplated. An electromagnetic cavity functions as a general-purpose physical nonlinear transformation module, applicable to any neural network sublayer requiring nonlinear mapping, including but not limited to convolutional layers, fully connected layers, and multi-layer perceptron (MLP) sublayers in transformer architectures. An electromagnetic cavity is a bounded electromagnetic volume defined by one or more walls and/or boundary surfaces that constrain propagation of electromagnetic energy such that transmitted waves undergo resonant behavior and/or multipath reflections within the volume. In implementations, the boundary surfaces can be conductive, reflective, absorptive, and/or selectively reflective/absorptive as a function of frequency and polarization, and can include one or more reconfigurable metasurfaces that controllably modify the cavity's scattering response. Examples of electromagnetic cavities include the volumes created by the radio frequency-based deep neural networks described herein, such as those shown in FIGS. 1A, 1B, 2, and 3.

Classification is the task of predicting the category or label of a given input based on its features. The phrase “machine learning” broadly describes a function of electronic systems that learn from data. A machine learning system, engine, or module can include a trainable machine learning algorithm that can be trained, such as in an external cloud environment, to learn functional relationships between inputs and outputs that are currently unknown, and the resulting model can be used for tasks, such as classification or prediction. In one or more embodiments, machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANN that are particularly useful at analyzing visual imagery.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activations of these input neurons are then passed to other downstream neurons, which are often referred to as “hidden” neurons. This process is repeated until an output neuron is activated. The activated output neuron determines which character was read. It should be appreciated that these same techniques can be applied in the case of denoising images or removing artefacts, which is useful for performing segmentation of CT voxel data.

Existing deep neural network implementations primarily rely on digital processing systems, which consume substantial power even for basic inference tasks and small-scale deployments. This power consumption becomes a critical bottleneck for applications requiring energy efficiency, particularly in edge computing and internet of things (IoT) scenarios where battery life and thermal constraints are significant concerns. While specialized low-power computing solutions exist, there remains a need for ultra-low-power neural network implementations across numerous applications, from mobile devices to autonomous systems. Current approaches like analog in-memory computing show promise but face scalability challenges. Among existing low-energy alternatives, optical neural networks have emerged as a mainstream solution. However, they face fundamental limitations in fully implementing various deep neural network architectures, particularly in composing different types of neural network layers within a single system.

To address these and other shortcomings, embodiments described herein provide a radio-frequency (RF)-based solution that overcomes these limitations by implementing both Convolutional Neural Networks (CNN) and Fully Connected Layers (FCL) within a single reconfigurable electromagnetic cavity. More broadly, embodiments described herein provide a physical nonlinear transformation generator. An electromagnetic cavity implements an arbitrary nonlinear mapping f(x) via wave propagation and scattering, serving as a drop-in replacement for any nonlinear sublayer in a neural network architecture. Embodiments support spatiotemporal processing, hybrid analog-digital or fully analog inference, heterogeneous tensor-core integration, co-processing with digital compute units, and chip-scale implementation.

One or more embodiments provide a way to build AI systems using RF signals and a reconfigurable chamber with adjustable panels referred to as “metasurfaces.” Unlike traditional digital computers—which rely on power-hungry silicon chips to process data step-by-step—one or more embodiments skip the need for digital calculations entirely. Instead, one or more embodiments perform AI task (e.g., recognizing images or making decisions) directly using radio frequency signals. By sending and receiving certain signals, a complex matrix calculation as part of the AI process occurs. One or more embodiments can switch between different types of AI operations (e.g., convolutional and fully connected layers) in a single device, making it energy-efficient and lightning-fast. Compared to light-based systems (e.g., Optical Neural Networks (ONN)), which struggle to combine different types of neural network layers in a single device and heavily relies on commercial parts (e.g., camera, monitors, etc.), one or more embodiments described herein is fully customizable and can be scaled and adapted to different problems.

Descriptions of various embodiments of the present disclosure are presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

According to one or more embodiments, a low-power computational device for artificial intelligence processing is provided and includes a configurable chamber equipped with adaptive panels designed for radio frequency operations. These panels are engineered to interact with proximate wireless signals for executing computations used to perform artificial intelligence operations and training procedures. According to one or more embodiments, such a system may include an enclosed radio frequency chamber with engineered sidewalls and electrically reconfigurable panels, where the sidewalls are engineered to be absorptive in some frequencies and reflective in other frequencies, and the panels are constructed from electrically reconfigurable/tunable metasurface structures. A spatial multiplexing system enables the co-existence of reflective and transmissive metasurfaces in a single chamber based on frequency and polarization multiplexing. Components that emit, capture, and process near-field wireless emissions are used.

One or more embodiments provides for the use of reconfigurable/tunable metasurface panels operating simultaneously in both transmission and reflection modes, where the input-output relationships of these signals through the tunable metasurfaces perform complex mathematical operations used for artificial intelligence operation computations. One or more embodiments maintains low power consumption by leveraging the inherent signal processing capabilities of the metasurface panels rather than through conventional binary digital computation.

According to one or more embodiments, an electromagnetic cavity system is provided that implements both Convolutional Neural Network (CNN) and Fully Connected Layer (FCL) functionalities using reconfigurable/tunable RF components within a single reconfigurable chamber. The system integrates transmissive and reflective metasurfaces to perform neural network operations directly in the electromagnetic domain without the help of digital computing engines to achieve ultra-low energy consumption and speed-of-light propagation.

According to an embodiment (see, e.g., FIG. 1A), CNN operations are implemented through:
Fully reflected sidewalls, to form a metallic cavity/Faraday cage;
Strategic positioning of transmit (Tx) and receive (Rx) antennas to capture spatial convolution results which is reflected and spatial modulated by multiple tunable reflective metasurfaces (Reflective Intelligent Surface, RIS); and
RF wave-based feature transformation, mapping the features in pixel domain to RF domain and achieves convolution processing.

According to another embodiment (see, e.g., FIG. 1B), FCL operations are implemented through:
Selective absorbing sidewalls, to form an open space boundary condition similar to a microwave anechoic chamber;
Transmissive metasurfaces with integrated antenna feeding structure, forms a linear algebra calculation system, implements direct electromagnetic domain matrix multiplication; and
Achieves the FCL operation through multi-pass matrix multiplication, updating the neuron values sequentially.

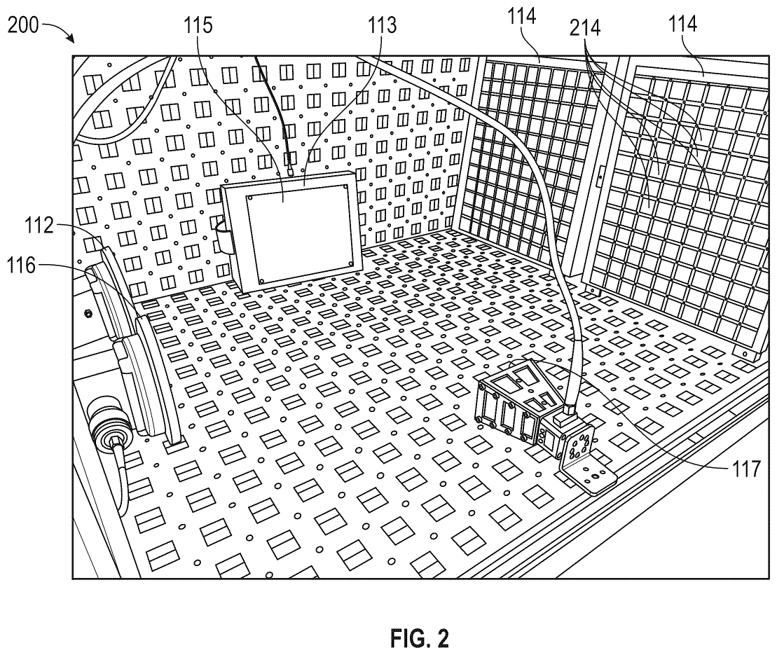

According to yet another embodiment (see, e.g., FIGS. 2 and 3), combine CNN operations and FCL operations capabilities in a single electromagnetic structure are provided through frequency and polarization multiplication, eliminating the need for separate hardware for different neural network layers and expanding the universality of RF-based analog neural networks and wave-based physical neural computing more generally, including use as a nonlinear transformation generator within larger digital or hybrid neural network architectures.

One or more embodiments provide heterogeneous tensor-core integration by extending beyond standalone RF processing to interface with heterogeneous computing backends including digital processors, analog in-memory computing arrays, and optical neural network processors. For example, an electromagnetic metasurface cavity may function as: a dimensionality reduction front-end feeding a digital tensor core (GPU, NPU, MCU); a nonlinear embedding reservoir feeding an analog in-memory computing (IMC) crossbar array; a feature extractor preceding an optical neural network (ONN) or photonic tensor processor; and/or a preprocessing compression module cascading into neuromorphic chips or mixed-signal accelerators.

One or more embodiments provide spatiotemporal embedding with modulated input by implementing time-varying metasurface control, injecting modulated waveforms including frequency-modulated continuous wave (FMCW) and phase-modulated waveforms, and generating a spatiotemporal readout derived from time-varying cavity responses. This provides for time-varying metasurface control synchronized with the input waveform, temporal multiplexing of neural weights across chirp sequences, and high-dimensional spatiotemporal embeddings that achieve virtual dimensionality scaling without increasing physical array size.

One or more embodiments provide a fully analog inference pipeline by eliminating analog-to-digital converter (ADC) and digital-to-analog converter (DAC) requirements, driving varactor-based tuning elements using direct analog signals and/or shift-register-generated bitstreams, and cascading an analog output to downstream analog compute circuitry. The metasurface tuning elements may be driven by the following alternative methods, eliminating the need for high-resolution DAC arrays: direct analog voltage excitation, where sensor or antenna output signals are amplified and directly applied to varactors, with the analog signal itself serving as both the input data and the bias voltage; shift-register-controlled digital voltage levels (bitstream), where instead of DACs, a bank of shift registers generates digital voltage levels (e.g., 1-bit or multi-bit) that are applied directly to varactors, which reduces circuit complexity and power while maintaining programmability; pulse-density modulation (PDM) streams, where time-averaged pulse streams produce effective analog voltage levels on varactors without dedicated DAC hardware; and envelope-detected or amplified sensor signals, where RF, acoustic, or other sensor outputs are conditioned via amplification or envelope detection and applied directly to the metasurface without digital conversion.

One or more embodiments provide chip-scale and heterogeneous packaging by implementing metasurfaces using complementary metal-oxide-semiconductor (CMOS)-compatible processes, integrating metasurface structures in monolithic microwave integrated circuit (MMIC) form factors, and supporting System-in-Package, three-dimensional stacking, and chiplet-based architectures. One or more embodiments are implemented as a PCB-level prototype including discrete metasurface panels, a radar module, and an MCU on a printed circuit board. One or more embodiments are implemented as a monolithic MMIC in which a metasurface array, a transceiver, and control logic are integrated on a single microwave integrated circuit die. One or more embodiments are implemented using a CMOS-compatible metasurface in which varactor arrays are fabricated using standard CMOS or SiGe processes for high-volume production. One or more embodiments are implemented using silicon interposer integration in which a metasurface die and a digital tensor core die are co-packaged on a silicon interposer with through-silicon vias (TSVs). One or more embodiments are implemented as a 3D stacked heterogeneous package including vertical stacking of metasurface, transceiver, and digital processor dies with inter-die interconnects. One or more embodiments are implemented as a chiplet-based system-in-package in which disaggregated chiplets including a metasurface, an RF front-end, and a digital backend are assembled in a shared package substrate.

One or more embodiments provide a physical nonlinear transformation generator and co-processing by configuring an electromagnetic cavity as a general-purpose nonlinear mapping module f(x) and using the cavity to replace a nonlinear sublayer, including a transformer MLP sublayer, in a pipelined digital-physical co-processing architecture. Nonlinearity arises from the physics of wave propagation: interference, diffraction, multiple reflections, and the voltage-dependent impedance of the metasurface tuning elements (e.g., varactors) introduce nonlinearities analogous to activation functions in digital neural networks. By reconfiguring the metasurface voltage state, the specific nonlinear mapping f(x) is changed, enabling the same physical hardware to implement different transformations for different layers or tasks. According to one or more embodiments, the nonlinear generator is the replacement of MLP sublayers in transformer architectures. A digital processor (e.g., CPU, GPU, NPU) executes linear operations (e.g., attention, normalization, residual connections), while the cavity performs the nonlinear MLP transformation via electromagnetic wave propagation. A learned digital projection layer (fc_back) maps the cavity's scattering output back to the model's embedding space. This is applicable to any transformer variant including GPT, LLaMA, BERT, and Vision Transformer architectures. According to one or more embodiments, a scheduler coordinates pipelined execution. The digital processor's linear computation for layer N+1 overlaps temporally with the cavity's nonlinear computation for layer N. For sufficiently large models where digital MLP computation time approaches the cavity's fixed propagation time, the co-processing architecture achieves throughput parity with purely digital execution while reducing power consumption and memory requirements, as MLP weight parameters are physically encoded in the metasurface configuration rather than stored in digital memory.

One or more embodiments provide multi-domain application generality by using the same cavity hardware to process ECG data, speech data, and image data, while adapting a digital readout for each modality to achieve modality-agnostic operation. According to one or more embodiments, the same electromagnetic cavity and reconfigurable metasurface processes inputs from different signal modalities by encoding each modality as a radio-frequency waveform and training only the digital readout layer for the target task. Consider the following examples: for ECG heartbeat classification, one-dimensional biomedical time-series signals are encoded as modulated RF input, with the scattering output classified into diagnostic categories; for speech command recognition, audio spectrograms are encoded as RF input patterns for spoken word classification; and for image classification, two-dimensional grayscale image data with multi-class labels are spatially encoded into the metasurface configuration.

Turning now to the figures, FIG. 1A shows a non-linear RF-based DNN 101 and FIG. 1B shows a linear RF-based DNN 102, each configured for radio frequency-based deep neural network operations according to one or more embodiments. Both figures feature a configurable chamber equipped with adaptive panels designed for radio frequency operations. In FIGS. 1A and 1B, the non-linear RF-based DNN 101 and the linear RF-based DNN 102 each represent an electromagnetic cavity (or “enclosure”), each cavity being a bounded electromagnetic volume defined by boundary surfaces (e.g., walls 118) and including one or more metasurfaces and one or more antennas that collectively constrain and control propagation and scattering of radio-frequency energy. As used throughout the present description, the term “cavity” refers to an electromagnetic propagation volume that may be implemented as a reconfigurable chamber, enclosure, reservoir cavity, or cavity spacer-defined volume, and that may be configured to support wave-based neural computation including reflective-cavity nonlinear processing, absorptive/open-boundary linear processing, spatiotemporal embedding, reservoir computing, and co-processing as a physical nonlinear transformation generator f(x), including in PCB-level, MMIC, interposer-based, stacked, and chiplet-based implementations. The term “cavity” may be used interchangeably with the following terms throughout the disclosure: electromagnetic cavity, electromagnetic propagation volume, bounded electromagnetic volume, reconfigurable chamber, enclosure, reservoir cavity, physical reservoir cavity, cavity spacer-defined volume, and electromagnetic cavity system.

The non-linear RF-based DNN 101 of FIG. 1A integrates several components that collectively perform neural network computations in the electromagnetic domain using a non-linear arrangement of components. A transmission antenna 112 transmits a radio-frequency wave into an electromagnetic cavity formed by the non-linear RF-based DNN 101. The radio-frequency wave is directed toward a metasurface 114, which is a selectively reconfigurable panel having tunable unit cells, referred to herein as “metasurface tuning elements.” The metasurface 114 is configured to generate a representation of the input using voltage values generated based on the input. This configuration enables the metasurface 114 to spatially modulate the incident radio-frequency wave, thereby encoding the input data into the electromagnetic domain.

The radio-frequency wave transmitted by the transmission antenna 112 is at least partially reflected off the metasurface 114. As the wave interacts with the metasurface 114, the wave is spatially modulated according to the programmed voltage values at the metasurface 114, resulting in a reflection wave that carries the transformed features of the input data.

A reception antenna 116 is positioned within the electromagnetic cavity of the non-linear RF-based DNN 101 to receive the reflection wave from the metasurface 114. The reception antenna 116 detects the modulated reflection wave from the metasurface 114, and a measurement is generated based on the received signal. This measurement is then used to perform an artificial intelligence operation, such as classification or inference, based on the transformed features encoded in the reflection wave.

The cavity walls 118 may be engineered to provide selective boundary conditions, such as reflective or absorptive properties, to further control the propagation and interaction of radio-frequency waves within the non-linear RF-based DNN 101. This configuration supports the implementation of convolutional neural network operations and enables performance of complex nonlinear transformations in the electromagnetic domain.

This configuration (FIG. 1A) supports the implementation of convolutional neural network operations in the electromagnetic domain, enabling efficient and scalable physical computation for artificial intelligence tasks.

Turning now to FIG. 1B, the linear RF-based DNN 102 is configured for radio frequency-based deep neural network operations according to one or more embodiments. A transmissive tunable metasurface 115 is provided within the linear RF-based DNN 102, and is configured to generate a representation of an input using voltage values generated based on the input. An integrated feeding antenna, which serves as the transmission antenna 113, is positioned in the near-field of the metasurface 115 and is configured to emit radio-frequency waves.

During operation, the transmission antenna 113 transmits a radio-frequency wave that passes through and is spatially modulated by the transmissive metasurface 115. The spatial modulation is determined by the voltage values applied to the metasurface tuning elements of the metasurface 115, thereby encoding the input data into the electromagnetic domain. The modulated radio-frequency wave then propagates through the cavity formed by the linear RF-based DNN 102, which is bounded by walls 118 configured to operate in an absorptive mode, minimizing internal reflections and supporting open boundary conditions.

A reception antenna 117 is positioned to receive the modulated wave after the modulated wave passes through the transmissive metasurface 115. The reception antenna 117 detects the resulting reception wave, which includes a calculation result corresponding to the artificial intelligence operation being performed. The system then executes the artificial intelligence operation based on the calculation result derived from the received signal.

This configuration (FIG. 1B) supports the implementation of fully connected layer operations in the electromagnetic domain, enabling efficient and scalable physical computation for artificial intelligence tasks.

FIGS. 2 and 3, which are now described together, illustrate a configuration of a RF-based DNN 200 (also referred to as an “electromagnetic cavity system”) that supports the non-linear and linear configurations of FIGS. 1A and 1B according to one or more embodiments.

In the embodiments of FIGS. 2 and 3, the RF-based DNN 200 integrates the components shown in FIGS. 1A and 1B, including transmission antennas 112 and 113, metasurfaces 114 and 115, and reception antennas 116 and 117. The arrangement demonstrates the physical implementation of both reflective and transmissive metasurfaces within a single electromagnetic cavity, supporting the combined operation of convolutional and fully connected neural network layers.

A plurality of metasurface tuning elements 214 are visible as part of the metasurface 114. Each metasurface tuning element 214 is individually addressable and configured to modulate the phase and/or amplitude of incident radio frequency waves based on applied voltage values. This enables dynamic reconfiguration of the metasurface response, supporting programmable electromagnetic transformations required for neural network operations. The walls 118, as shown in FIGS. 1A, 1B, 2, and 3, can include metasurfaces such that the walls 118 are themselves metasurfaces.

The configuration in FIGS. 2 and 3 highlights the practical realization of a reconfigurable RF-based DNN system, where the integration of reflective and transmissive metasurfaces, along with their associated antennas, enables versatile analog neural network processing within a unified hardware platform.

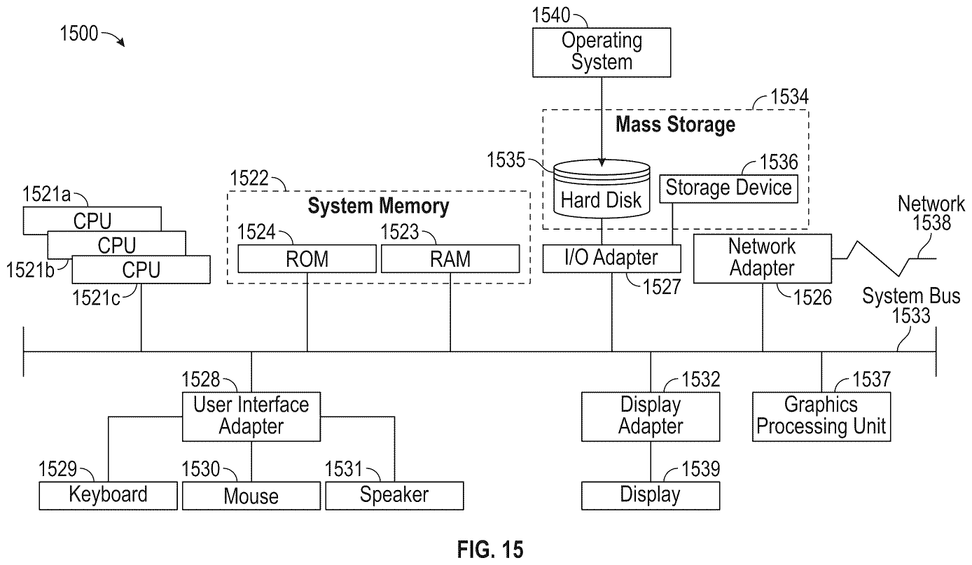

According to one or more embodiments, the input provided to the non-linear RF-based DNN 101 of FIG. 1A, the linear RF-based DNN 102 of FIG. 1B, and/or the RF-based DNN 200 of FIGS. 2 and 3 can be generated or provided by any suitable system, such as processing system 1500 of FIG. 15. Similarly, the output of the non-linear RF-based DNN 101 of FIG. 1A, the linear RF-based DNN 102 of FIG. 1B, and/or the RF-based DNN 200 of FIGS. 2 and 3 can be sent or provided to any suitable system, such as processing system 1500 of FIG. 15.

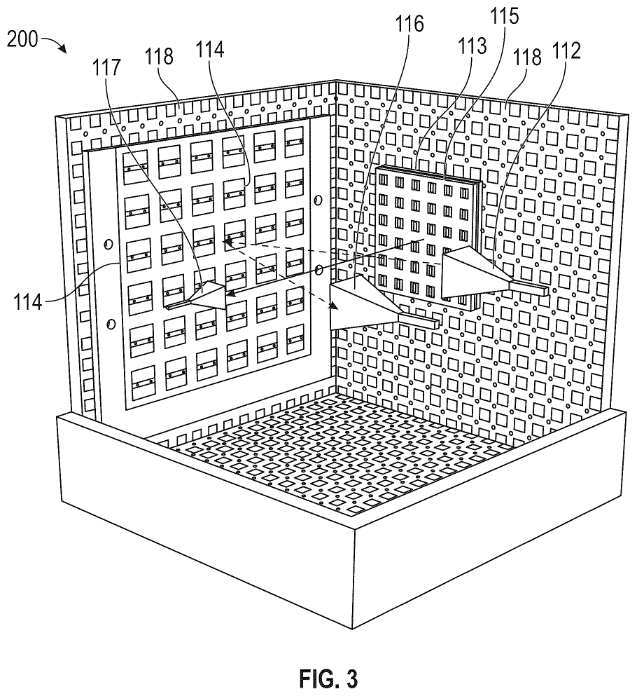

FIG. 4 illustrates an RF-based DNN process 400 for performing artificial intelligence operations such as digit classification using the Modified National Institute of Standards and Technology (MNIST) database as input. The RF-based DNN process 400 involves preprocessing an original MNIST image 410 by resizing and normalizing at operation 412, then encoding the data as voltage values 414 for input 416 to an in-silico trainable parameters module 430 and as input 418 to an RF cavity silicon double 420. A reconfigurable intelligent surface (RIS) 422 (e.g., one of metasurfaces 114, 115) modulates the RF waves, and the resulting measurement 424 is used as input to the in-silico trainable parameters module 430. A DNN 432 with convolutional and fully connected layers generates output 434 based on input 416, which is used for training parameters 436. The network performs forward propagation to generate a final output 440 and then performs backward propagation 442, 444 to update parameters 436 and the DNN 432. The RF-based DNN process 400 leverages electromagnetic wave-based computation for efficient feature transformation and classification.

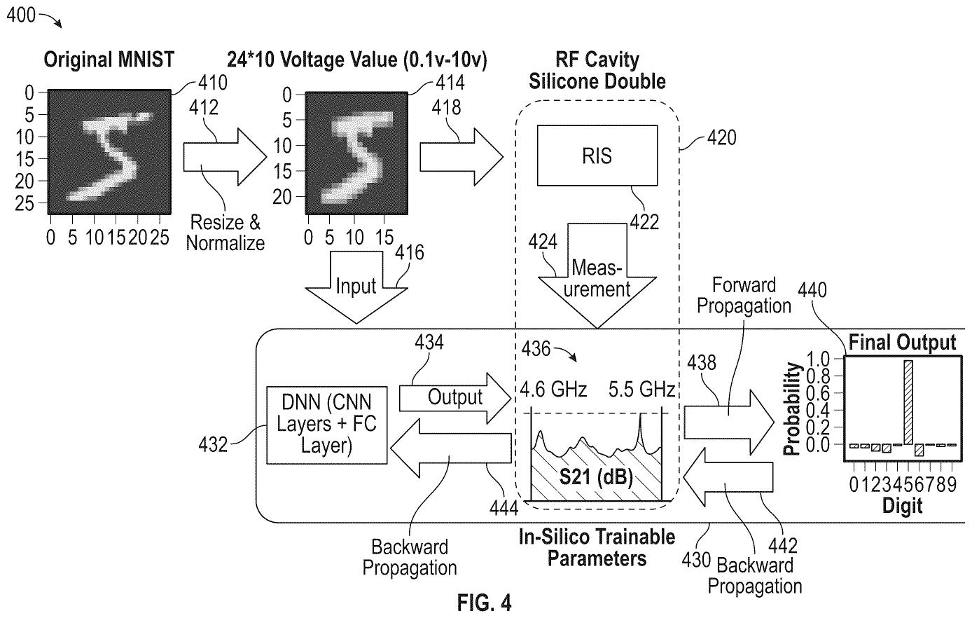

FIG. 5 illustrates a confusion matrix 500 illustrating classification performance of an example RF-based DNN, such as those described herein, using the MNIST digit classification example of FIG. 4. The horizontal axis labeled “Predicted” indicates the class output by the classifier, and the vertical axis labeled “Digit” indicates the ground-truth class for each input sample. Each cell of the confusion matrix 500 contains a percentage representing a proportion of samples having the corresponding ground-truth class that were assigned to the corresponding predicted class.

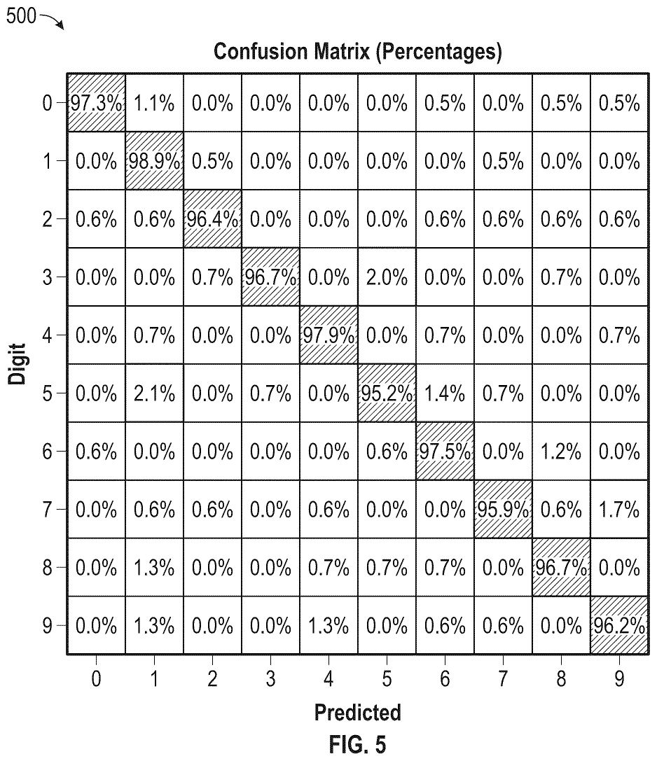

FIG. 6 illustrates a spatiotemporal embedding architecture 600 according to one or more embodiments, showing time-varying metasurface control synchronized with modulated input waveforms to produce high-dimensional spatiotemporal embeddings. One or more embodiments described herein support spatiotemporal neural processing. In addition to static spatial metasurface configurations, the metasurface panel configuration (e.g., metasurface 114) may be time-varying and synchronized with a time-varying input waveform 602. This temporal modulation introduces an additional computational dimension, enabling high-dimensional spatiotemporal embeddings that achieve virtual dimensionality scaling without increasing the physical array size. For example, a physically small array (e.g., 64 by 64 elements) can emulate a much larger effective input space (e.g., 512 by 512) by encoding computation in time through synchronized chirp sequences and metasurface weight updates.

According to one or more embodiments, the time-varying input waveform 602 may be one or more of: a continuous wave (CW) signal, a frequency-modulated continuous wave (FMCW) chirp signal, a phase-modulated signal, an amplitude-modulated signal, a multi-tone excitation signal, and/or an arbitrary waveform. RF-based DNN response varies with the input waveform frequency, phase, or amplitude, and the metasurface configuration (time-varying metasurface state 604) may change across successive waveform periods (e.g., chirps), such that neural encoding occurs simultaneously across space, time, frequency, and polarization domains.

According to one or more embodiments, a spatiotemporal embedding output 606 extends from purely spatial to spatiotemporal. The received signal is sampled across multiple chirps or time slots, producing a two-dimensional spatiotemporal embedding (e.g., range-bin by chirp-index) from a single analog-to-digital converter (ADC) channel. The spatiotemporal embedding output 606 captures both the spatial scattering response and its temporal evolution as the metasurface configuration changes, thereby compressing high-resolution input data into dense, low-dimensional feature vectors via electromagnetic wave scattering.

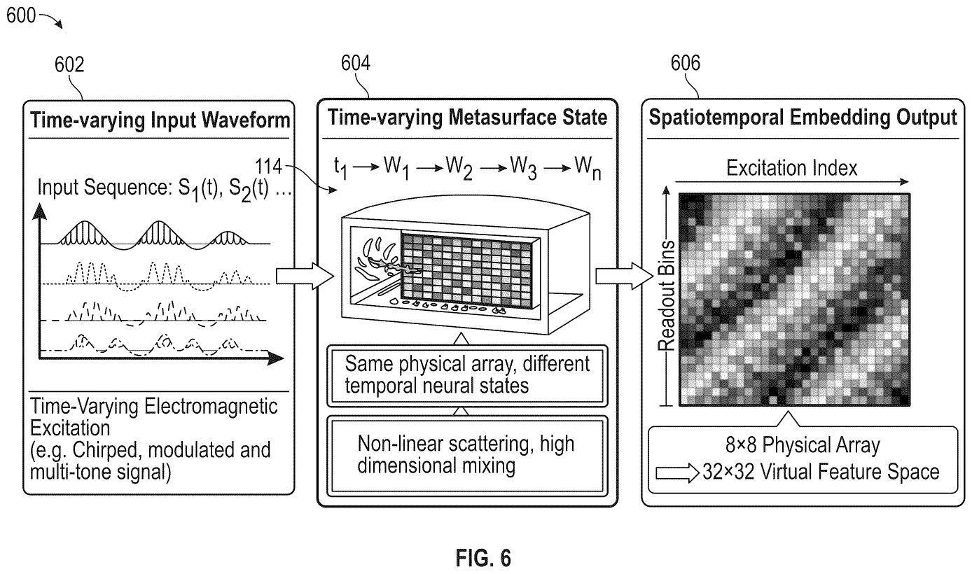

FIG. 7 depicts a fully analog inference pipeline 700 according to one or more embodiments, showing DAC-free varactor excitation methods and ADC-free cascaded output to a secondary analog computing stage. The fully analog inference pipeline 700 supports DAC-less analog drive methods 702, which feed the metasurface tuning elements 214 and a DAC-less electromagnetic analog neural processing module 718, which together generate ADC-less analog outputs 704.

One or more embodiments described herein support fully analog inference without requiring DACs or ADCs. In an embodiment, the metasurface tuning elements 214 (e.g., varactors) are driven by direct analog voltage excitation and sensor or antenna output signals are amplified and directly applied to the varactors, with the analog signal itself serving as both the input data and the bias voltage. In another embodiment, the metasurface tuning elements 214 are driven by digital voltage levels generated by shift registers (bitstream control), and a bank of shift registers produces 1-bit or multi-bit voltage levels applied directly to the varactors without DAC hardware. In yet another embodiment, pulse-density modulation (PDM) streams may be used, which provides for time-averaged pulse streams to produce effective analog voltage levels on the varactors. In still another embodiment, envelope-detected or amplified sensor signals from RF, acoustic, or other sources are conditioned and applied directly to the metasurface tuning elements 214.

According to one or more embodiments, the output electromagnetic signal (e.g., ADC-less analog outputs 704) from the metasurface tuning elements 214 is routed without digitization to a secondary analog computing stage, namely DAC-less electromagnetic analog neural processing module 718, which provides direct analog coupling between neural stages. The received signal may be amplified or attenuated to appropriate voltage levels and directly applied to an analog in-memory computing (IMC) crossbar array as an input vector. In another embodiment, the received signal may be converted to an optical signal via electro-optic modulation and fed into an optical neural network (ONN) or photonic tensor processor. The output may also cascade into additional electromagnetic neural layers (e.g., a second metasurface cavity or stage), creating a multi-stage all-analog physical neural inference pipeline without any intermediate digital conversion.

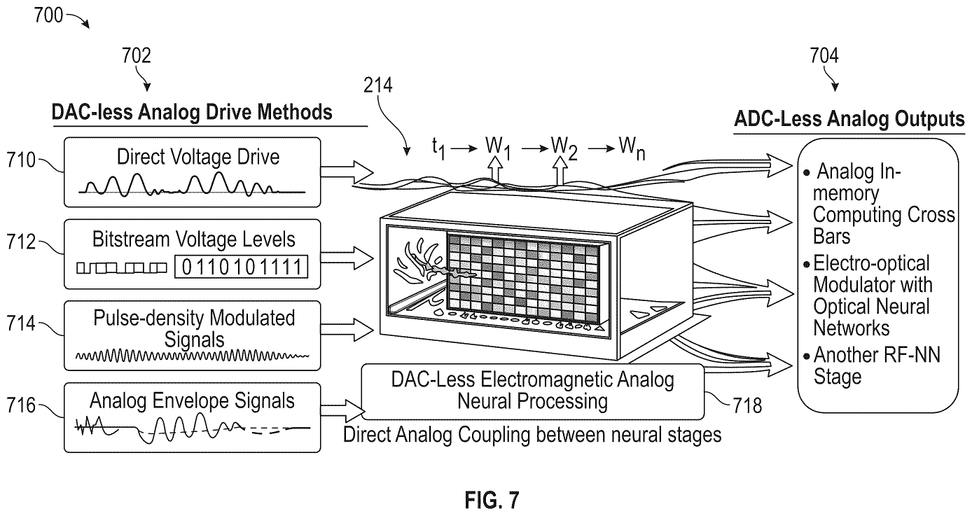

FIG. 8 depicts a PCB-level implementation for an RF-based DNN 800 according to one or more embodiments. This embodiment shows a disassembled view of the RF-based DNN 800 that includes a first layer PCB 801, a second layer metasurface 802, a third layer cavity spacer 803, and a fourth layer radar board 804.

The first layer PCB 801 provides a structural and electrical substrate for the RF-based DNN 800. The first layer PCB 801 can carry routing traces, power distribution, control lines, and mounting features for components associated with metasurface biasing, signal conditioning, and/or interfacing to external control or processing circuitry. According to one or more embodiments, the first layer PCB 801 includes built-in DAC controllers 811 configured to generate bias and/or control voltages for metasurface tuning elements 814 of the metasurface 802. The DAC controllers 811 can provide individually addressable voltage settings for respective metasurface tuning elements 814 to implement a programmed spatial phase and/or amplitude profile. In some embodiments, the DAC controllers 811 are coupled to a digital control interface that loads metasurface configuration states and updates such states during operation.

The second layer metasurface 802 includes a reconfigurable metasurface including the metasurface tuning elements 814 arranged as an array. The metasurface 802 is configured to spatially modulate an incident radio-frequency wave according to applied control voltages, thereby encoding an input representation into the electromagnetic domain and enabling a programmable electromagnetic transformation used for an artificial intelligence operation.

The third layer cavity spacer 803 defines at least a portion of an electromagnetic cavity volume and sets a separation distance between the metasurface 802 and the fourth layer radar board 804. The cavity spacer 803 can include a conductive and/or absorptive structure (e.g., walls 118) that establishes desired boundary conditions for propagation and scattering within the cavity and mechanically aligns the stacked layers of the RF-based DNN 800.

The fourth layer radar board 804 includes RF transmit and receive circuitry and includes a radar transmission antenna 812 and a radar reception antenna 816. The radar board 804 is configured to generate a radio-frequency wave for injection into the cavity using the radar transmission antenna 812 and to receive, via the radar reception antenna 816, a resulting signal after interaction with the metasurface 802, the received signal being used to generate measurements that support performance of an artificial intelligence operation.

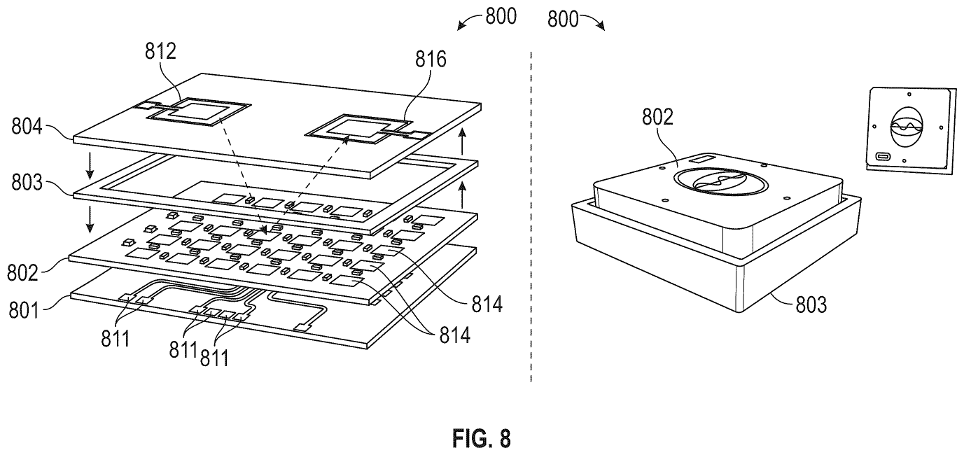

FIG. 9 depicts a cross-section of an RF-based DNN 900 according to one or more embodiments. In this embodiment, a vertically stacked package is shown and includes a PCB substrate 902, a metasurface MMIC die as GaAs substrate 906 with varactor diodes 907, a physical reservoir cavity formed via an interposer 908, and a radar/digital SoC die as silicon substrate 910 with on-wafer antennas (e.g., transmission antenna 112, reception antenna 116), radar transceiver 912, analog-to-digital converter 914, and digital tensor core 916.

In one or more embodiments, the PCB substrate 902 provides a package-level mechanical support and an electrical interface for the vertically stacked an RF-based DNN 900. The PCB substrate 902 can include routing layers, power distribution, control signaling, and external connectors to couple the stacked dies to off-package circuitry, and can further include landing pads and other features to support electrical interconnect to the dies in the stack.

The metasurface MMIC die, implemented as a GaAs substrate 906, carries metasurface structures and associated tuning circuitry configured to controllably modulate an electromagnetic field within the stack. The GaAs substrate 906 is connected to the PCB substrate 902 via electrical interconnects 904. The GaAs substrate 906 can support high-frequency operation and can integrate a plurality of metasurface tuning elements (e.g., varactor diodes 907) whose impedance and/or scattering response is adjustable to implement programmable boundary conditions for wave-based neural processing. More particularly, the varactor diodes 907 are an example of metasurface tuning elements, which are tunable impedance elements coupled to respective metasurface unit cells and configured to change an effective capacitance in response to an applied bias.

The physical reservoir cavity (e.g., the third layer cavity spacer 803 of FIG. 8) is formed via an interposer 908 that defines a separation distance between the metasurface MMIC die (e.g., GaAs substrate) and the radar/digital SoC die (e.g., silicon substrate 910). The interposer 908 establishes a cavity volume in which electromagnetic propagation and multipath scattering occur. The interposer 908 can further provide mechanical alignment features and electrical feedthroughs and, in some implementations, can be configured with conductive, reflective, and/or absorptive regions to set boundary conditions for the cavity response.

In one or more embodiments, the radar/digital SoC die is implemented as a silicon substrate 910 and integrates RF transceiver circuitry and digital processing resources used to excite, capture measurements, and execute at least a portion of an artificial intelligence workload. The silicon substrate 910 can include on-wafer antennas, such as a transmission antenna 112 and a reception antenna 116, to couple electromagnetic energy as described herein, thereby enabling inference and/or training based on measured scattering responses.

In one or more embodiments, the radar transceiver 912 is configured to generate and condition transmit signals applied to the transmission antenna 112 and to condition receive signals acquired via the reception antenna 116. The radar transceiver 912 can include frequency generation and modulation circuitry, amplification, filtering, and downconversion circuitry to produce one or more intermediate-frequency or baseband signals representing a measurement of the cavity response.

In one or more embodiments, the analog-to-digital converter 914 digitizes an analog signal received from the radar transceiver 912 and provides the digitized signal to the digital tensor core 916. The digital tensor core 916 performs one or more digital computations associated with the artificial intelligence operation, including linear algebra operations, readout computation, post-processing, and/or co-processing with the cavity as a nonlinear transformation stage. The digital tensor core 916 can be configured to execute matrix multiplication, normalization, attention-related operations, and/or projection operations that map measured cavity outputs into an embedding space used by a neural network model.

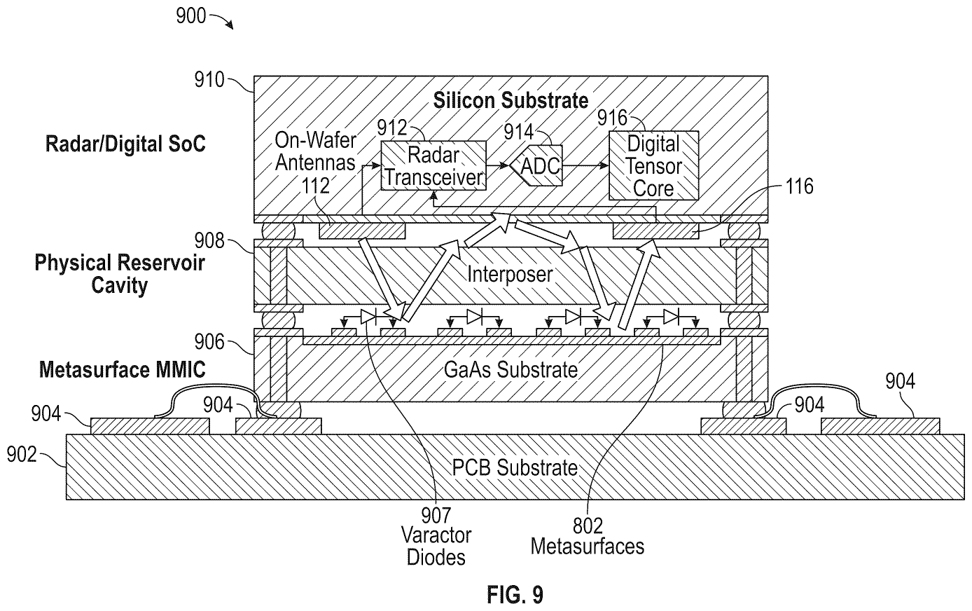

FIG. 10 depicts an architecture 1000 for various neural operation modes according to one or more embodiments, including a reservoir computing mode 1004, a closed-loop calibrated inference mode 1006, and a layer-scheduled reconfigurable non-linearity generator mode 1008. An input vector x 1001, encoded as metasurface states, is provided to a radio frequency neural network (RFNN) core 1002 that implements a spatiotemporal electromagnetic physical nonlinear transform f(x). The RFNN core 1002 generates a scattered output 1003 corresponding to f(x), which can be used as a feature representation for an artificial intelligence operation. The architecture 1000 further illustrates that the same RFNN Core 1002 can be operated in a plurality of modes, including a reservoir computing mode 1004, a closed-loop calibrated inference mode 1006, and a layer-scheduled reconfigurable non-linearity generator mode 1008, wherein a controller or processing systems selects and/or schedules metasurface configurations to realize a desired transformation behavior for a particular task or neural network layer depending on the operating mode.

One or more embodiments described herein support neural operation modes beyond CNN and FCL, including but not limited to: reservoir computing mode 1004, where the cavity functions as a high-dimensional nonlinear reservoir with fading memory and only the readout layer is trained; dynamic weight modulation, where neural weights are updated in real-time during inference via time-varying metasurface configuration; adaptive or context-aware inference, where the system adapts its embedding based on environmental or signal context without full retraining; self-calibrating physical inference (e.g., closed-loop calibrated inference mode 1006), where a digital backend fine-tunes readout weights to correct for physical deviations between simulation and hardware; and nonlinear temporal memory effects, where the cavity's dispersive response creates inherent short-term memory for processing sequential data.

The reservoir computing mode 1004 involves the cavity functioning as a high-dimensional nonlinear reservoir with fading memory. The metasurface configuration is fixed after initialization, and the linear readout layer is trained. The cavity's dispersive response provides inherent short-term memory for sequential data processing. No weight updates occur during inference.

The closed-loop calibrated inference mode 1006 uses a digital calibrator to monitor inference output and adjust either readout weights, the metasurface configuration, or both, based on feedback or environmental context. This mode encompasses sim-to-real calibration (correcting fabrication tolerances), environmental drift compensation (temperature, humidity, aging), and context-aware adaptation (selecting the configuration based on SNR, interference, or target type).

The layer-scheduled reconfigurable non-linearity generator mode 1008 involves reconfiguring the metasurface configuration per layer, time-step, or task from a pre-trained configuration library. This mode encompasses transformer MLP replacement (per transformer block), spatiotemporal embedding (changes per chirp period), and multi-task inference (per task type). A pipelined scheduler coordinates the digital processor and cavity in parallel.

According to one or more embodiments, the architecture 1000 with reconfigurable metasurface functions as a general-purpose physical nonlinear transformation generator. The input vector x 1001, represented as a radio-frequency signal, is injected into the cavity via one or more transmission antennas (e.g., transmission antenna 112). The cavity's multipath scattering, resonant mode mixing, and metasurface-controlled boundary conditions collectively implement a high-dimensional nonlinear mapping f(x) using the RFNN core 1002, whose output is captured at one or more reception antennas (e.g., reception antenna 116) as scattering parameters (e.g., S21) (e.g., the scattered output 1003). The nonlinear transformation arises from the physics of wave propagation: interference, diffraction, multiple reflections, and the voltage-dependent impedance of the metasurface tuning elements (e.g., varactors) introduce nonlinearities analogous to activation functions in digital neural networks. By reconfiguring the metasurface voltage state, the specific nonlinear mapping f(x) is changed, enabling the same physical hardware to implement different transformations for different layers or tasks.

According to one or more embodiments, the physical nonlinear transformation generator (e.g., RFNN core 1002) replaces one or more nonlinear sublayers in a multi-layer neural network executing on a digital processor. The digital processor (e.g., tensor processor 1102) executes linear operations, normalization, attention computations, and residual connections, while the RFNN core 1002 (i.e., the electromagnetic cavity) performs nonlinear transformations that would otherwise be computed as multi-layer perceptron (MLP) sublayers, fully connected layers, or nonlinear activation stages. In one embodiment, the cavity replaces the MLP sublayer within each transformer block of a transformer neural network, wherein the digital processor computes attention (including query, key, value projections and score computation) and the cavity computes the nonlinear MLP transformation via electromagnetic wave propagation. A learned digital projection layer (fc_back) maps the cavity's scattering output back to the model's embedding space. This partitioning is applicable to any transformer variant including but not limited to GPT, LLaMA, BERT, and Vision Transformer architectures.

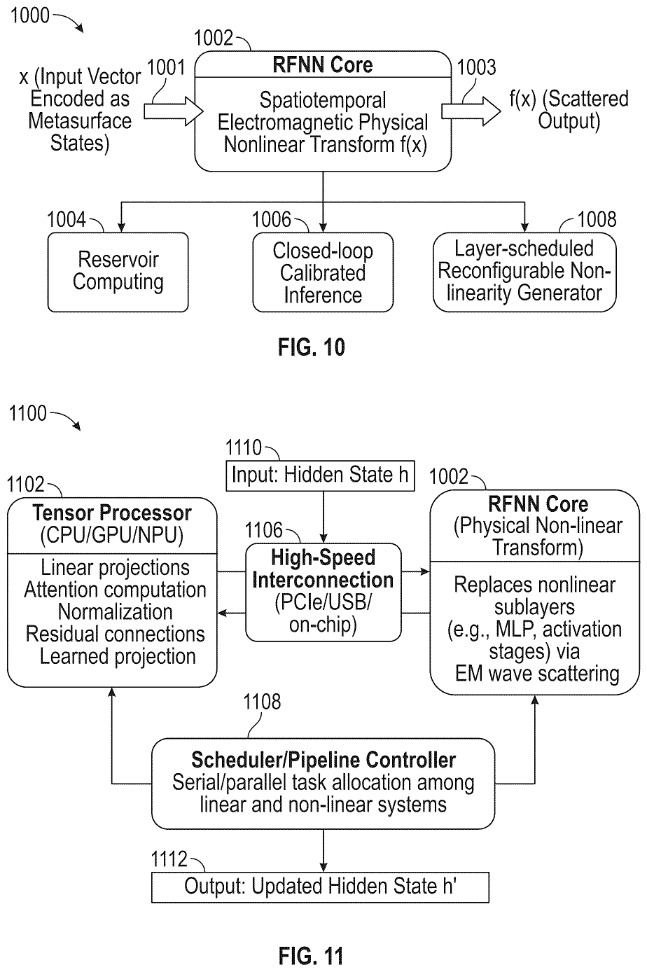

FIG. 11 depicts a co-processing architecture 1100 for neural network inference according to one or more embodiments, showing a digital processor executing linear operations (attention, normalization, residual connections) and an electromagnetic cavity executing nonlinear transformations (MLP sublayer replacement) in a pipelined scheduler arrangement, with data transfer via a high-speed bus between the digital processor and the cavity. The co-processing architecture 1100 utilizes a tensor processor and the RFNN core for co-processing of inputs 1110, which may define a hidden state h, to generate an output 1112, which defines an updated hidden state h′.

According to one or more embodiments, the RFNN core 1002 is coupled to a secondary computing element for hybrid processing. The secondary computing element (also referred to a “secondary processor”) (e.g., tensor processor 1102) may be a digital tensor processing unit (e.g., GPU, neural processing unit (NPU), or microcontroller unit (MCU) with tensor core), an analog in-memory computing (IMC) crossbar array, an optical neural network (ONN) processor, a photonic tensor core, or a neuromorphic computing chip). In this configuration, the electromagnetic cavity functions as a dimensionality reduction front-end, a nonlinear embedding reservoir, a feature extractor, or a preprocessing compression module, while the secondary computing element (e.g., tensor processor 1102) performs final classification, generation, or decision-making operations. This heterogeneous architecture enables partitioning of the computational workload between analog wave-based physics and digital or secondary analog processing.

According to one or more embodiments, the architecture 1100 may be implemented at various levels of integration, including: a printed circuit board (PCB)-level prototype with discrete metasurface panels, radar module, and microcontroller; a monolithic microwave integrated circuit (MMIC) with the metasurface array, transceiver, and control logic on a single die; a CMOS-compatible or SiGe semiconductor die with varactor arrays fabricated using standard processes; a silicon interposer-based multi-die package with the metasurface die and digital tensor core die co-packaged via through-silicon vias (TSVs); a vertically stacked three-dimensional (3D) heterogeneous package with metasurface, transceiver, and digital processor dies; or a chiplet-based system-in-package (SiP) with disaggregated chiplets for metasurface, RF front-end, and digital backend assembled in a shared package substrate.

The tensor processor 1102 is communicatively coupled to the RFNN core 1002 via a high-speed interconnect (e.g., PCIe, USB, on-chip interconnect).

According to one or more embodiments, a scheduler 1108 coordinates execution by the RFNN core 1002 and/or the tensor processor 1102 in a pipelined fashion. For each layer of the neural network, the scheduler 1108 transitions through states including: (1) digital computation of linear operations (normalization, attention, residual connections); (2) transfer of the intermediate hidden state from the digital processor to the cavity via a data bus (e.g., PCIe, USB, or on-chip interconnect); (3) physical nonlinear transformation in the cavity, during which the metasurface is set to the voltage configuration corresponding to the current layer; and (4) transfer of the scattering output back to the tensor processor 1102 and/or RFNN core 1002 for the learned projection and residual addition. In pipelined mode, the RFNN core's 1002 linear computation for layer N+1 overlaps temporally with the cavity's nonlinear computation for layer N, such that the throughput bottleneck is determined by the slower of the two stages. For sufficiently large models where the digital MLP computation time approaches or exceeds the cavity's fixed propagation time, the co-processing architecture achieves throughput parity with or improvement over purely digital execution while reducing power consumption and memory requirements, as the MLP weight parameters are physically encoded in the metasurface configuration rather than stored in digital memory.

It should be appreciated that the embodiments described herein are applicable across multiple input data domains without modification to the cavity hardware. The same electromagnetic cavity and reconfigurable metasurface architecture processes inputs from different signal modalities by encoding each modality as a radio-frequency waveform and training the digital readout layer for the target task. For example, an embodiment provides for classifying one-dimensional biomedical time-series signals, such as electrocardiogram (ECG) heartbeat waveforms, by encoding the time-series as a modulated RF input and classifying the scattering output into diagnostic categories. Another embodiment involves performing speech command recognition by encoding audio spectrograms as RF input patterns. Yet another embodiment provides for classifying two-dimensional image data, including grayscale and multi-class image datasets, by spatially encoding pixel intensities into the metasurface configuration or input waveform. These multi-domain results demonstrate the generality of the RF-based DNNs described herein as a physical nonlinear transformation generator that is not limited to a single data type, input dimensionality, or classification task.

According to one or more embodiments, the CNN and FCL are two independent systems, which share the cavity but not the functionalities. The FCL is realized by transmissive metasurfaces. The CNN is realized by reflective metasurfaces. These two systems are integrated into the same cavity, as shown in FIG. 9, through frequency/polarization multiplexing (which means they are operating at different frequencies or polarizations).

For the operation of FCL, the wave launched by the integrated feeding is spatially modulated by the transmissive metasurface, so the received wave by the Rx (receiving/reception) antenna contains the calculation result, which is done by the modulation process of the transmissive metasurface. In this case, the walls (including the reflective metasurface, which we regard as a part of wall) are absorptive, meaning there is no reflected wave back into the cavity.

Same concept is implemented with CNN, where the transmissive metasurface forms a part of the wall to be reflective, so that the wave generated by the Tx antenna will be bounced to the reflective metasurfaces and bounded inside the cavity to give the structure non-linearity.

To support the operations of FCL and CNN within the same cavity, polarization and frequencies are used to distinguish both types of metasurfaces, for example, in polarization 1 and frequencies 1, reflective metasurface will be reflective, and the walls will be reflective, as well as the transmissive metasurface (CNN), in polarization 2 and frequencies 2, reflective metasurface and wall will be absorptive, and transmissive metasurface will be transmissive (FCL).

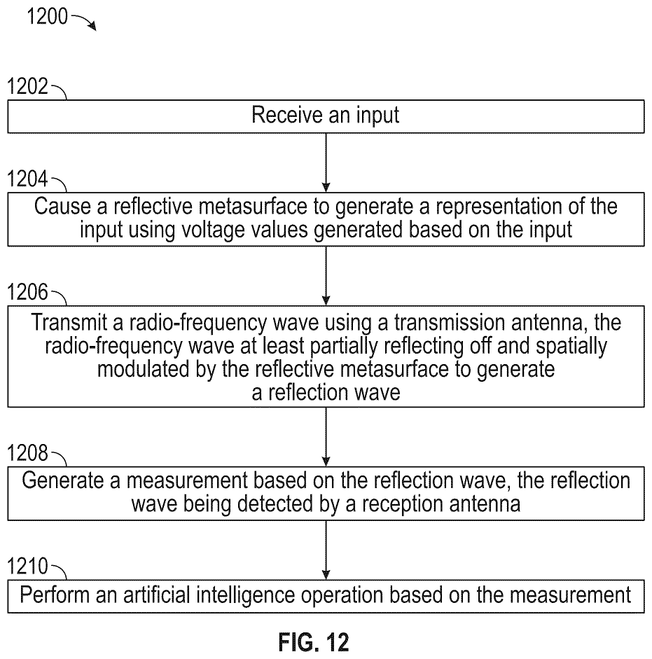

FIG. 12 illustrates a flow diagram of a method 1200 for performing an artificial intelligence operation using a radio frequency-based deep neural network according to one or more embodiments. The method 1200 can be performed by any suitable system, device, or environment, such as those described herein and depicted in FIGS. 1-11. The method 1200 is now described as being performed using the non-linear RF-based DNN 101 of FIG. 1A but is not so limited.

At operation 1202, the RF-based DNN 101 receives an input. At operation 1204, a reflective metasurface (e.g., metasurface 114) generates a representation of the input using voltage values generated based on the input. At operation 1206, a transmission antenna (e.g., transmission antenna 112) transmits a radio-frequency wave, the radio-frequency wave at least partially reflecting off and spatially modulated by the reflective metasurface to generate a reflection wave. At operation 1208, a measurement is generated based on the reflection wave, the reflection wave being detected by a reception antenna (e.g., reception antenna 116). At operation 1210, an artificial intelligence operation (e.g., training a machine learning model, performing inference using a trained machine learning model, performing classification, performing regression; performing feature extraction (embedding generation)) is performed based on the measurement.

According to one or more embodiments, the artificial intelligence operation is one of training a machine learning model or performing inference using a trained machine learning model.

According to one or more embodiments, the reflective metasurface, the transmission antenna, and the reception antenna are arranged to implement convolutional neural network operations.

According to one or more embodiments, an output of the RF-based DNN 101 is coupled to a secondary processor selected from the group consisting of: a digital tensor processing unit, an analog in-memory computing array, an optical neural network processor, a photonic tensor core, and a neuromorphic computing chip.

According to one or more embodiments, the metasurface configuration of the reflective metasurface is time-varying and synchronized with a modulated input waveform, and the reflection wave is processed across spatial and temporal dimensions to generate the measurement, which is a spatiotemporal embedding having an effective dimensionality exceeding a physical array dimension.

According to one or more embodiments, metasurface tuning elements are excited by an analog signal with amplification or by digital voltage levels of a bitstream generated by shift registers, wherein the metasurface tuning elements are excited without performing digital-to-analog conversion, and wherein the measurement is coupled, with amplification, to a secondary analog computing element without performing analog-to-digital conversion.

According to one or more embodiments, the reflective metasurface, the transmission antenna, and a computing element are integrated in a form selected from a group consisting of a monolithic microwave integrated circuit, a CMOS-compatible semiconductor die, a heterogeneous multi-die package with silicon interposer, a vertically stacked three-dimensional package, and a chiplet-based system-in-package.

According to one or more embodiments, the method 1200 further includes implementing a nonlinear transformation f(x) of an input vector x via multipath scattering and metasurface-controlled boundary conditions, wherein the nonlinear transformation f(x) replaces a nonlinear sublayer of a multi-layer neural network executing on a digital processor.

According to one or more embodiments, the method 1200 further includes processing the input from a plurality of signal modalities without modification to the non-linear radio frequency-based deep neural network, the plurality of signal modalities including two or more of one-dimensional biomedical time-series signals, audio signals or spectrograms thereof, and two-dimensional image data, wherein for each signal modality of the plurality of signal modalities, a corresponding digital readout layer is trained.

According to one or more embodiments, the transmitting is performed within an electromagnetic cavity having boundary walls configured to reflect at least in part at an operating frequency to increase internal reflections.

Additional processes also may be included, and it should be understood that the processes depicted in FIG. 12 represent illustrations, and that other processes may be added or existing processes may be removed, modified, or rearranged without departing from the scope of the present disclosure.

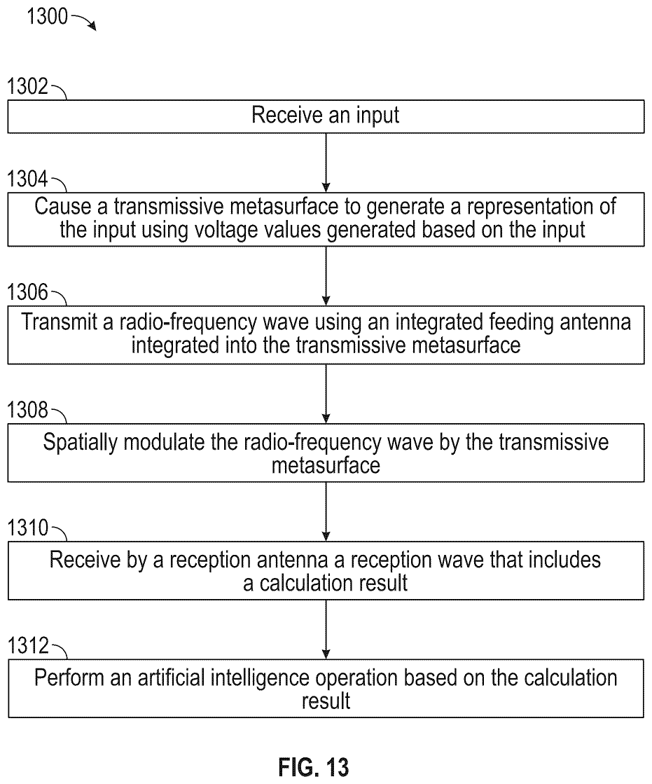

FIG. 13 illustrates a flow diagram of a method 1300 for performing an artificial intelligence operation using a radio frequency-based deep neural network according to one or more embodiments. The method 1300 can be performed by any suitable system, device, or environment, such as those described herein and depicted in FIGS. 1-11. The method 1300 is now described as being performed using the linear RF-based DNN 102 of FIG. 1B but is not so limited.

At operation 1302, the linear RF-based DNN 102 receives an input. At operation 1304, a transmissive metasurface (e.g., transmissive metasurface 115) generates a representation of the input using voltage values generated based on the input. At operation 1306, an integrated feeding antenna (e.g., transmission antenna 113) integrated into the transmissive metasurface (e.g., metasurface 115) transmits a radio-frequency wave. At operation 1308, the transmissive metasurface spatially modulates the radio-frequency wave. At operation 1310, a reception antenna (e.g., reception antenna 117) receives a reception wave that includes a calculation result. At operation 1312, an artificial intelligence operation (e.g., training a machine learning model, performing inference using a trained machine learning model, performing classification, performing regression; performing feature extraction (embedding generation)) is performed based on the calculation result.

According to one or more embodiments, wherein the transmissive metasurface includes a plurality of individually addressable metasurface tunable units, each including a varactor diode that provides a voltage-controlled impedance for modulating at least one of the phase and the amplitude of the radio-frequency wave.

According to one or more embodiments, the transmitting and the receiving are performed within an electromagnetic cavity having boundary walls configured to absorb at least in part at an operating frequency to reduce internal reflections.

Additional processes also may be included, and it should be understood that the processes depicted in FIG. 13 represent illustrations, and that other processes may be added or existing processes may be removed, modified, or rearranged without departing from the scope of the present disclosure.

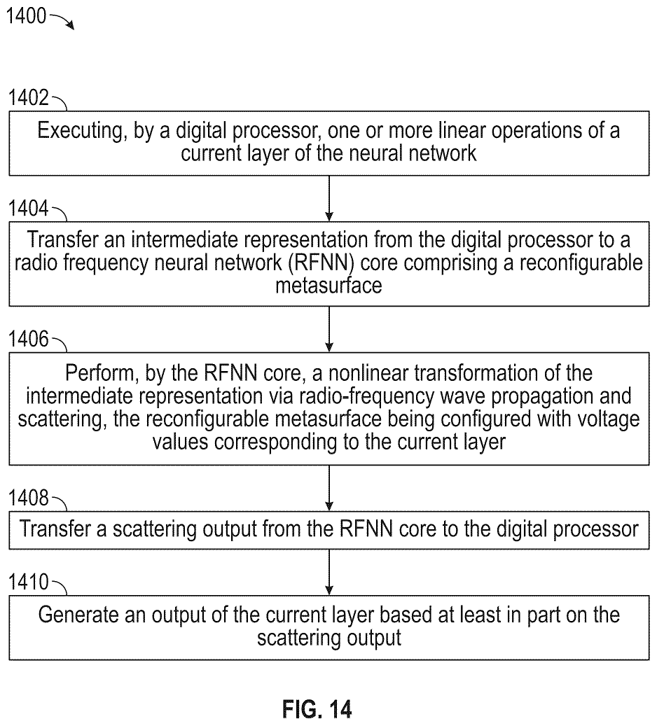

FIG. 14 illustrates a flow diagram of a method 1400 for performing inference using a neural network comprising a plurality of layers according to one or more embodiments. The method 1400 can be performed by any suitable system, device, or environment, such as those described herein and depicted in FIGS. 1-11. The method 1400 is now described as being performed using the co-processing architecture 1100 of FIG. 11 but is not so limited.

At operation 1402, a digital processor (e.g., the tensor processor 1102) executes one or more linear operations of a current layer of the neural network. At operation 1404 the method 1400 includes transferring an intermediate representation from the digital processor to a radio frequency neural network (RFNN) core (e.g., RFNN core 1002) comprising a reconfigurable metasurface (e.g., metasurface 114, 115). At operation 1406, the RFNN core performs a nonlinear transformation of the intermediate representation via radio-frequency wave propagation and scattering, the reconfigurable metasurface being configured with voltage values corresponding to the current layer. At operation 1408, the method 1400 includes transmitting a scattering output from the RFNN core to the digital processor. At operation 1410, the method 1400 includes generating an output of the current layer based at least in part on the scattering output.

According to one or more embodiments, the neural network is a transformer neural network, the one or more linear operations include attention computation comprising query, key, and value projections and attention score computation, and the nonlinear transformation replaces a multi-layer perceptron (MLP) sublayer within a transformer block.

According to one or more embodiments, the digital processor is selected from the group consisting of: a digital tensor processing unit, an analog in-memory computing array, an optical neural network processor, a photonic tensor core, and a neuromorphic computing chip.

According to one or more embodiments, the method 1400 further includes coordinating, by a scheduler (e.g., scheduler 1108), pipelined execution between the digital processor and the RFNN core, wherein the digital processor executes the one or more linear operations for a subsequent layer while the RFNN concurrently performs the nonlinear transformation for the current layer.

Additional processes also may be included, and it should be understood that the processes depicted in FIG. 14 represent illustrations, and that other processes may be added or existing processes may be removed, modified, or rearranged without departing from the scope of the present disclosure.

One or more embodiments provide technical improvements in energy efficiency by performing at least a portion of neural network computation in the electromagnetic domain using wave propagation and scattering rather than clocked digital arithmetic. In some implementations, this reduces power consumption by orders of magnitude relative to purely digital accelerators for comparable inference tasks, for example on the order of substantially 1/1000 of the power of digital chips in representative use cases. One or more embodiments also provide technical improvements in processing speed by exploiting physical propagation of radio-frequency waves to effect transformations with low latency, including performing matrix-like transformations without traversing long, power-hungry digital datapaths associated with conventional multiply-accumulate pipelines.

One or more embodiments further provide technical improvements in functional versatility by enabling multiple neural network layer types to be implemented by a common physical platform. For example, a single reconfigurable cavity can be configured to implement CNN operations and FCL operations, and can be reconfigured between these modes without replacing hardware, thereby avoiding separate specialized processing units for different layer classes. One or more embodiments also provide technical improvements in scalability by increasing effective feature dimensionality through spatial configuration and, in some implementations, spatiotemporal modulation, thereby improving representational capacity without proportionally increasing the physical footprint or the number of discrete compute elements. In addition, embodiments maintain efficiency as model size grows by encoding transformations into reconfigurable boundary conditions of the cavity and metasurfaces, which can reduce the amount of data movement and memory access that typically dominates energy consumption in digital systems.

One or more embodiments provide architectural flexibility to implement any combination of convolutional and fully connected processing in the RF domain, including by selecting reflective versus absorptive boundary conditions and by controlling interactions between transmissive and reflective metasurfaces. One or more embodiments also provide technical improvements relative to optical approaches by leveraging RF operation that can offer higher dynamic range in practical systems and can reduce or avoid reliance on external optical components and associated amplification chains, thereby improving power efficiency and simplifying system integration. One or more embodiments directly implement neural network operations through reconfigurable metasurfaces that spatially modulate incident wavefields, enabling physical computation via controlled scattering rather than digitally computed activation maps. In some implementations, a single-cavity configuration reduces the need for multiple processing units and reduces domain conversions between different compute substrates, which can further reduce latency, power consumption, and system complexity. These technical improvements are enabled by tunable metasurfaces, controllable unit cells (e.g., voltage-programmable elements), and strategic placement of transmission and reception antennas that together realize configurable electromagnetic transformations suitable for power-efficient and scalable physical neural computing.

It is understood that one or more embodiments described herein is capable of being implemented in conjunction with any other type of computing environment now known or later developed. For example, FIG. 15 depicts a block diagram of a processing system 1500 for implementing the techniques described herein. In examples, processing system 1500 has one or more central processing units (“processors” or “processing resources” or “processing devices”) 1521a, 1521b, 1521c, etc. (collectively or generically referred to as processor(s) 1521 and/or as processing device(s)). In aspects of the present disclosure, each processor 1521 can include a reduced instruction set computer (RISC) microprocessor. Processors 1521 are coupled to system memory (e.g., random access memory (RAM) 1524) and various other components via a system bus 1533. Read only memory (ROM) 1522 is coupled to system bus 1533 and may include a basic input/output system (BIOS), which controls certain basic functions of processing system 1500.

Further depicted are an input/output (I/O) adapter 1527 and a network adapter 1526 coupled to system bus 1533. I/O adapter 1527 may be a small computer system interface (SCSI) adapter that communicates with a hard disk 1523 and/or a storage device 1525 or any other similar component. I/O adapter 1527, hard disk 1523, and storage device 1525 are collectively referred to herein as mass storage 1534. Operating system 1540 for execution on processing system 1500 may be stored in mass storage 1534. The network adapter 1526 interconnects system bus 1533 with an outside network 1536 enabling processing system 1500 to communicate with other such systems.

A display 1535 (e.g., a display monitor) is connected to system bus 1533 by display adapter 1532, which may include a graphics adapter to improve the performance of graphics intensive applications and a video controller. In one aspect of the present disclosure, adapters 1526, 1527, and/or 1532 may be connected to one or more I/O busses that are connected to system bus 1533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 1533 via user interface adapter 1528 and display adapter 1532. A keyboard 1529, mouse 1530, and speaker 1531 may be interconnected to system bus 1533 via user interface adapter 1528, which may include, for example, a Super I/O chip integrating multiple device adapters into a single integrated circuit.

In some aspects of the present disclosure, processing system 1500 includes a graphics processing unit 1537. Graphics processing unit 1537 is a specialized electronic circuit designed to manipulate and alter memory to accelerate the creation of images in a frame buffer intended for output to a display. In general, graphics processing unit 1537 is very efficient at manipulating computer graphics and image processing, and has a highly parallel structure that makes it more effective than general-purpose CPUs for algorithms where processing of large blocks of data is done in parallel.

Thus, as configured herein, processing system 1500 includes processing capability in the form of processors 1521, storage capability including system memory (e.g., RAM 1524), and mass storage 1534, input means such as keyboard 1529 and mouse 1530, and output capability including speaker 1531 and display 1535. In some aspects of the present disclosure, a portion of system memory (e.g., RAM 1524) and mass storage 1534 collectively store the operating system 1540 to coordinate the functions of the various components shown in processing system 1500.

As used herein, the term “controller” refers to a dedicated controller including a processor and a memory, a general controller including control modules configured to enact a control process using the dedicated controller, a network of multiple distinct controllers in communication with each other and each including processors and memory and being configured to cooperatively implement the control process, and any similar configuration for implementing the techniques described herein, including but not limited to the method 1200 of FIG. 12 and/or the method 1300 of FIG. 13.

Various embodiments are described herein with reference to the related drawings. Alternative embodiments can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the embodiments described herein are not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for performing an artificial intelligence operation using a non-linear radio frequency-based deep neural network, the method comprising:
receiving an input;
causing a reflective metasurface to generate a representation of the input using voltage values generated based on the input;
transmitting a radio-frequency wave using a transmission antenna, the radio-frequency wave at least partially reflecting off and spatially modulated by the reflective metasurface to generate a reflection wave;
generating a measurement based on the reflection wave, the reflection wave being detected by a reception antenna; and
performing the artificial intelligence operation based on the measurement.

2. The method of claim 1, wherein a wavefront is changed by changing a phase and a magnitude of subwavelength unit-cells.

3. The method of claim 1, wherein a metasurface configuration of the reflective metasurface is time-varying and synchronized with a modulated input waveform, and the reflection wave is processed across spatial and temporal dimensions to generate the measurement, which is a spatiotemporal embedding having an effective dimensionality exceeding a physical array dimension.

4. The method of claim 1, wherein metasurface tuning elements are excited by an analog signal with amplification or by digital voltage levels of a bitstream generated by shift registers, wherein the metasurface tuning elements are excited without performing digital-to-analog conversion, and wherein the measurement is coupled, with amplification, to a secondary analog computing element without performing analog-to-digital conversion.

5. The method of claim 1, wherein the reflective metasurface, the transmission antenna, and a computing element are integrated in a form selected from a group consisting of a monolithic microwave integrated circuit, a CMOS-compatible semiconductor die, a heterogeneous multi-die package with silicon interposer, a vertically stacked three-dimensional package, and a chiplet-based system-in-package.

6. The method of claim 1, further comprising implementing a nonlinear transformation f(x) of an input vector x via multipath scattering and metasurface-controlled boundary conditions, wherein the nonlinear transformation f(x) replaces a nonlinear sublayer of a multi-layer neural network executing on a digital processor.

7. The method of claim 1, further comprising processing the input from a plurality of signal modalities without modification to the non-linear radio frequency-based deep neural network, the plurality of signal modalities including two or more of one-dimensional biomedical time-series signals, audio signals or spectrograms thereof, and two-dimensional image data, wherein for each signal modality of the plurality of signal modalities, a corresponding digital readout layer is trained.

8. The method of claim 1, wherein the transmitting is performed within an electromagnetic cavity having boundary walls configured to reflect at least in part at an operating frequency to increase internal reflections.

9. A system comprising:
an enclosure comprising a plurality of walls, a top and a bottom;
a reflective metasurface;
a transmission antenna; and
a reception antenna,
wherein at least one of the plurality of walls includes a reflective/absorptive portion, the reflective/absorptive portion configured to reflect radio-frequency waves in a first bandwidth and configured to absorb radio-frequency waves in a second bandwidth different than the first bandwidth.

10. The system of claim 9, wherein the reflective metasurface comprises a plurality of cells arranged in a matrix and being configured to reflect radio-frequency waves with additional phase shifts from individual unit-cells based at least in part on a voltage input for each of the plurality of cells.

11. The system of claim 9, further comprising a transmissive metasurface comprising an integrated feeding antenna placed in near-field of metasurface cells and configured to emit the radio-frequency waves.

12. The system of claim 9, further comprising a controller that:
receives an input;
causes the reflective metasurface to generate a representation of the input using voltage values generated based on the input;
causes a radio-frequency wave to be generated and transmitted using the transmission antenna, the radio-frequency wave at least partially reflecting off and spatially modulated with the reflective metasurface to generate a reflection wave;
causes a measurement to be generated based on the reflection wave, the reflection wave being detected by the reception antenna; and
performs an artificial intelligence operation based on the measurement.

13. The system of claim 9, further comprising a controller that:
receives an input;
causes a transmissive metasurface to generate a representation of the input using voltage values generated based on the input;
transmits a radio-frequency wave using an integrated feeding antenna integrated into the transmissive metasurface;
spatially modulates the radio-frequency wave by the transmissive metasurface;
receives by the reception antenna a reception wave that includes a calculation result;
performs an artificial intelligence operation based on the calculation result,
wherein at least one of the plurality of walls is absorbing.

14. The system of claim 9, wherein the system is selectively configurable operate in a mode selected from a group of modes consisting of: a convolutional neural network mode, a fully connected layer mode, a reservoir computing mode, a layer-scheduled reconfigurable non-linearity generator mode, and a closed-loop calibrated inference mode.

15. The system of claim 9, further comprising a digital processor, a radio frequency neural network (RFNN) core, and a scheduler, wherein the reflective metasurface is a reconfigurable metasurface that replaces a nonlinear sublayer of a neural network executing on the digital processor, and wherein the scheduler coordinates pipelined transfer of intermediate hidden states between the digital processor and the RFNN core via a data bus.

16. The system of claim 15, wherein the digital processor is selected from the group consisting of: a digital tensor processing unit, an analog in-memory computing array, an optical neural network processor, a photonic tensor core, and a neuromorphic computing chip.

17. A method for performing inference using a neural network comprising a plurality of layers, the method comprising:
executing, by a digital processor, one or more linear operations of a current layer of the neural network;
transferring an intermediate representation from the digital processor to a radio frequency neural network (RFNN) core comprising a reconfigurable metasurface;
performing, by the RFNN core, a nonlinear transformation of the intermediate representation via radio-frequency wave propagation and scattering, the reconfigurable metasurface being configured with voltage values corresponding to the current layer;
transferring a scattering output from the RFNN core to the digital processor; and
generating an output of the current layer based at least in part on the scattering output.

18. The method of claim 17, wherein the neural network is a transformer neural network, the one or more linear operations include attention computation comprising query, key, and value projections and attention score computation, and the nonlinear transformation replaces a multi-layer perceptron (MLP) sublayer within a transformer block.

19. The method of claim 17, wherein the digital processor is selected from the group consisting of: a digital tensor processing unit, an analog in-memory computing array, an optical neural network processor, a photonic tensor core, and a neuromorphic computing chip.

20. The method of claim 17, further comprising coordinating, by a scheduler, pipelined execution between the digital processor and the RFNN core, wherein the digital processor executes the one or more linear operations for a subsequent layer while the RFNN concurrently performs the nonlinear transformation for the current layer.
